(19) United States
(12) Patent Application Publication
(10) Pub. No.: US 2026/0031445 A1
(43) Pub. Date: Jan. 29, 2026

(54) EXTINGUISHING SHEET ASSEMBLY, A BATTERY PACK INCLUDING THE SAME AND AN ELECTRIC VEHICLE INCLUDING THE BATTERY PACK

(71) Applicant: SAMSUNG SDI CO., LTD., Yongin-si (KR)

(72) Inventors: Jeehoon JEON, Yongin-si (KR); Gwangtaek YOON, Yongin-si (KR); Janggun AHN, Yongin-si (KR); Jungkyun JUNG, Yongin-si (KR); Jaemin KIM, Yongin-si (KR)

(21) Appl. No.: 19/216,479

(22) Filed: May 22, 2025

(30) Foreign Application Priority Data
Jul. 26, 2024 (KR) 10-2024-0099758

(51) Int. Cl. H01M 50/143; H01M 10/658; H01M 50/505

(52) U.S. Cl. CPC H01M 50/143; H01M 10/658; H01M 50/505; H01M 2220/20

(57) ABSTRACT

An extinguishing sheet assembly, a battery pack including the extinguishing sheet assembly, and an electric vehicle including the battery pack are disclosed. The extinguishing sheet assembly may include an extinguishing sheet including an extinguishing agent, and a case in which the extinguishing sheet is detachably received and includes an exposed area. The case may include a body, a plurality of legs extended from the body to support the body, and a receiving portion extended from the body and into which the extinguishing sheet is inserted.

### CROSS-REFERENCE TO RELATED APPLICATION

The present application claims priority to and the benefit of Korean Patent Application No. 10-2024-0099758, filed on Jul. 26, 2024, in the Korean Intellectual Property Office, the entire content of which is incorporated herein by reference.

### BACKGROUND

### 1. Field

One or more embodiments of the present disclosure relate to an extinguishing sheet assembly, a battery pack including the extinguishing sheet assembly, and an electric vehicle including the battery pack.

### 2. Description of the Related Art

A rechargeable battery differs from a primary battery in that the former may be (e.g., designed to be) repeatedly charged and discharged while the latter should not be or is incapable of being recharged. Low-capacity rechargeable batteries are used in small, portable electronic devices, such as smartphones, feature phones, laptop computers, digital cameras, and/or camcorders. In contrast, large-capacity rechargeable batteries are used as driving power sources for motors in hybrid vehicles and/or electric vehicles and as power storage sources for energy storage systems (ESSs). Such rechargeable batteries include an electrode assembly including a positive electrode and a negative electrode, a case to accommodate the electrode assembly, and electrode terminals connected to the electrode assembly.

Rechargeable batteries may be divided into modules manufactured by stacking two or more cells and packs manufactured by stacking two or more modules. Manufacturers produce these modules and packs in one or more suitable shapes. Currently, battery manufacturers are trying to control a thermal runaway event at a module level and/or a pack level, and one of their approaches is by reducing heat propagation to cells that are around (or surrounding cells) during thermal runaway.

To extinguish ignition due to thermal runaway, extinguishing agents are applied to the modules and/or the packs. For example, to mitigate ignition (or reduce a degree or occurrence of ignition) caused by thermal runaway—a condition where an increase in temperature causes further increases in temperature—extinguishing agents are applied to the modules and/or packs. For rapid extinguishment, it is desired or required that an extinguishing agent be provided in modules and/or packs so that it can be discharged in one or more suitable directions.

The information disclosed herein in the background technology of this present disclosure is only to provide understanding of the background of present disclosure, and therefore may include information that does not constitute related art.

### SUMMARY

One or more aspects of embodiments of the present disclosure are directed toward an extinguishing sheet assembly, a battery pack including the extinguishing sheet assembly, and an electric vehicle including the battery pack, that are capable of more effectively or suitably suppressing or reducing heat transmission in a battery pack.

Additional aspects of embodiments will be set forth in part in the description which follows and, in part, will be apparent from the description or may be learned by practice of the presented embodiments of the disclosure.

According to one or more embodiments, an extinguishing sheet assembly includes an extinguishing sheet including an extinguishing agent, and a case in which the extinguishing sheet is detachably received and includes an exposed area, and the case may include a body, a plurality of legs extended from the body to support the body, and a receiving portion extended from the body and into which the extinguishing sheet is inserted.

The receiving portion may include a guide portion to support the extinguishing sheet while contacting a second surface of the extinguishing sheet and a first connecting portion connected to/with the guide portion and the body, wherein an area in contact between the guide portion and the second surface may be equal to or greater than a thickness of the extinguishing sheet.

In the extinguishing sheet assembly, a plurality of receiving portions may be further provided.

The plurality of receiving portions may include the receiving portion, wherein each of the plurality of receiving portions includes a guide portion to support the extinguishing sheet while contacting a second surface of the extinguishing sheet and a first connecting portion connected to the guide portion and the body, and wherein an area in contact between the guide portion and the second surface is equal to or greater than a thickness of the extinguishing sheet.

At least one or more selected from among the guide portions of the respective receiving portions may be connected to each other.

The case may further include a movement restriction portion extended from the body to restrict a movement of the extinguishing sheet in a longitudinal direction.

The movement restriction portion may include a second connecting portion extended from the body and a protrusion extended from the second connecting portion in a thickness direction of the extinguishing sheet.

The body may have an opening.

The body may further include a support member in the opening.

The support member may include a projection protruded in a thickness direction of the extinguishing sheet.

The plurality of legs may have a snap-fit structure.

The case may be configured or arranged to expose about 70% or more of a total area of the extinguishing sheet.

The extinguishing agent may be a solid aerosol.

According to one or more embodiments, a battery pack includes a battery module including a plurality of battery cells, a module case to accommodate the battery module, a busbar assembly on the battery module for electrical connection of the plurality of battery cells, and the extinguishing sheet assembly as described in one or more embodiments that is removably attached to the busbar assembly.

The battery pack may include at least one selected from among a first insulating sheet on the busbar assembly to suppress or reduce heat propagation, a second insulating sheet between adjacent battery cells among the plurality of battery cells to suppress or reduce heat propagation, a third insulating sheet between the busbar assembly and the battery module to suppress or reduce heat propagation, and a fourth insulating sheet between the battery module and the module case.

According to one or more embodiments, an electric vehicle includes one or more of the battery packs as described in one or more embodiments. For example, the electric vehicle according to one or more embodiment of the present disclosure to solve the technical object may include one or more of the battery packs as described in one or more embodiments.

According to the present disclosure, the extinguishing sheet accommodated in the case may have an increased exposed area.

According to the present disclosure, the extinguishing sheet may react immediately to the ambient temperature.

According to the present disclosure, a larger amount of aerosol extinguishing gas may be discharged from a case in one or more suitable ways.

According to the present disclosure, the extinguishing sheet may be easily replaced.

According to the present disclosure, the extinguishing sheet assembly may be removably attached to a battery module.

Furthermore, for example, the integration of the extinguishing sheet assembly within the battery pack enhances the overall safety and reliability of the electric vehicle. This integration ensures that in the event of a thermal runaway, the extinguishing sheet may promptly or suitably mitigate or reduce the risk by effectively or suitably suppressing or reducing heat transmission. Consequently, this not only protects the individual battery cells and the modules they form but also extends the lifespan of the entire battery pack, contributing to the durability and performance of the electric vehicle.

However, the aspects, effects, and/or embodiments of the present disclosure are not restricted to the one set forth herein. The above and other aspects, effects, and/or embodiments of the present disclosure will become more apparent to one of daily skill in the art to which the present disclosure pertains by referencing the appended claims and equivalents thereof and the accompanying drawings.

### BRIEF DESCRIPTION OF THE DRAWINGS

The accompanying drawings included in the present disclosure illustrate embodiments of the subject matter of the present disclosure and, together with the description, serve to explain principles of embodiments of subject matter of the present disclosure. Thus, the present disclosure should not be construed as being limited to the accompanying drawings.

FIG. 1 is a perspective view of a battery pack according to one or more embodiments of the present disclosure.

FIG. 2 is an exploded perspective view of the battery pack as illustrated in FIG. 1.

FIG. 3 is a perspective view of an extinguishing sheet assembly according to one or more embodiments of the present disclosure.

FIG. 4 is a partial cross-sectional view illustrating an extinguishing sheet assembly coupled to a battery pack.

FIG. 5 illustrates a process of inserting or removing an extinguishing sheet into or from a case of an extinguishing sheet assembly.

FIG. 6 is a cross-sectional view along the line VI-VI as shown in FIG. 3.

FIG. 7 is a bottom view of the extinguishing sheet assembly as illustrated in FIG. 3.

FIG. 8A is a bottom view of an extinguishing sheet assembly including one receiving portion according to one or more embodiments of the present disclosure.

FIG. 8B is a bottom view of an extinguishing sheet assembly including two receiving portions but with each guide portion connected according to one or more embodiments of the present disclosure.

FIG. 8C is a bottom view of an extinguishing sheet assembly including three receiving portions according to one or more embodiments of the present disclosure.

FIG. 9 is a cross-sectional view along the line VIII-VIII as shown in FIG. 3.

FIG. 10 is a view illustrating an action of an extinguishing sheet assembly.

FIG. 11A is a top view of a battery pack including two extinguishing sheet assemblies according to one or more embodiments of the present disclosure.

FIG. 11B is a top view of a battery pack including six extinguishing sheet assemblies according to one or more embodiments of the present disclosure.

FIG. 11C is a top view of a battery pack including eight extinguishing sheet assemblies according to one or more embodiments of the present disclosure.

FIG. 12 is a graph of a comparison of a heat propagation suppression or reduction effect of a battery pack according to an example of the present disclosure and a battery pack according to a comparative example.

FIG. 13 is a side view of an electric vehicle including a battery pack according to one or more embodiments of the present disclosure.

### DETAILED DESCRIPTION

Hereinafter, the subject matter of the present disclosure will be described in more detail with reference to the accompanying drawings. If (e.g., when) describing one or more embodiments with reference to the accompanying drawings, substantially the same or corresponding elements are denoted by the same reference numerals, and redundant descriptions thereof may be omitted. For convenience of illustration, sizes of elements in the drawings may be exaggerated or reduced. For example, because sizes and thicknesses of elements in the drawings are arbitrarily illustrated for convenience of explanation, embodiments of the present disclosure are not limited thereto.

The subject matter of the present disclosure may be embodied in one or more suitable different forms and should not be construed as being limited to only the illustrated embodiments herein. Rather, these embodiments are provided as examples so that the present disclosure will be thorough and complete and will fully convey the aspects and features of the present disclosure to those skilled in the art. Accordingly, processes, elements, and techniques that are not necessary to those having ordinary skill in the art for a complete understanding of the aspects and features of the present disclosure may not be described.

It will be further understood that the terms “have,” “having,” “includes,” and “including,” if (e.g., when) used in the present disclosure, specify the presence of the stated features, integers, steps, operations, elements, and/or components, but do not preclude the presence or addition of one or more other features, integers, steps, operations, elements, components, and/or groups thereof. For example, it should be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

In the present disclosure, expressions, such as “at least one of,” “one of,” and “selected from among,” if (e.g., when) preceding a list of elements, modify the entire list of elements and do not modify the individual elements of the list. For example, “at least one of X, Y, and Z,” “at least one of X, Y, or Z,” and “at least one selected from among the group consisting of X, Y, and Z” may be construed as X only, Y only, Z only, a (e.g., any suitable) combination of two or more of X, Y, and Z, such as, for instance, XYZ, XYY, XZ, YZ, and ZZ, or a (e.g., any suitable) variation thereof. Similarly, the expression, such as “at least one of A and/or B” may include A, B, or A and B. As used herein, the term “and/or” includes any and all combinations of one or more of the associated listed items. For example, the expression, such as “A and/or B” may include A, B, or A and B. Further, the use of “may” if (e.g., when) describing embodiments of the present disclosure refers to “one or more embodiments of the present disclosure”.

The use of “can/may” in describing an embodiment of the present disclosure indicates “at least one or more embodiments of the present disclosure.”

In one or more embodiments, to facilitate understanding of the present disclosure, the accompanying drawings may not be drawn to actual scale and the dimensions of one or more components may be exaggerated. Furthermore, the same reference numbers may be assigned to substantially the same components in different embodiments.

As used herein, the term “substantially,” “about,” “approximately,” and similar terms are used as terms of approximation and not as terms of degree and are intended to account for the inherent deviations in measured or calculated values that may be recognized by those of ordinary skill in the art. “About” or “approximately,” as used herein, is inclusive of the stated value and refers to as being within an acceptable range of deviation for the particular value as determined by one of ordinary skill in the art, considering the measurement in question and the error associated with measurement of the particular quantity (e.g., the limitations of the measurement system). For example, “about” may refer to as being within one or more standard deviations, or within ±30%, ±20%, ±10%, or ±5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Describing that two objects of comparison are “the same” refers to that they are “substantially the same.” Therefore, substantially identical or the same may include a deviation that is considered low in the art, for example, a deviation of less than about 5%.

In one or more embodiments, uniformity of a parameter in a certain region may refer to uniformity from an average perspective.

Although the first, the second, and/or the like are used to describe one or more suitable components, it goes without saying that these components are not limited by these terms. These terms are only used to distinguish one component from another component, and unless specifically stated to the contrary, the first component may also be a second component.

Throughout the present disclosure, unless otherwise stated, each component may be singular or plural.

Disposition of any component to the “upper (or lower) portion” of the component or to the “upper (or lower)” portion of the component may indicate that not only is an arbitrary component arranged in contact with the upper (or lower) surface of the component, but also other components may be between the component and any component arranged on (or under) the component.

It will be understood that if (e.g., when) an element, a layer, a region, or a component is referred to as being “formed on,” “arranged on,” “on,” “connected to,” or “coupled to” another element, layer, region, or component, it may be directly formed on, directly arranged on, directly on, directly connected to, or directly coupled to the other element, layer, region, or component, or indirectly formed on, indirectly arranged on, indirectly on, indirectly connected to, or indirectly coupled to the other element, layer, region, or component such that one or more intervening elements, layers, regions, or components may be present therebetween. For example, if (e.g., when) a layer, a region, or a component is referred to as being “electrically connected” or “electrically coupled” to another layer, region, or component, it may be directly electrically connected or coupled to the other layer, region, and/or component or intervening layers, regions, or components may be present therebetween. However, “directly connected/directly coupled” refers to one component directly connecting or coupling another component without an intermediate component present therebetween.

In one or more embodiments, other expressions describing relationships between components, such as “between,” “immediately between,” or “adjacent to,” and “directly adjacent to” may be construed similarly. In one or more embodiments, it will also be understood that if (e.g., when) an element or layer is referred to as being “between” two elements or layers, it may be the only element or layer between the two elements or layers, or one or more intervening elements or layers may also be present.

Whenever reference is made throughout the present disclosure to “A and/or B,” this refers to A, B, or A and B, unless otherwise specified. For example, “and/or” includes all or any combination of the listed items. If (e.g., when) referring to “C to D,” this refers to C or higher and D or lower, unless specifically stated to the contrary.

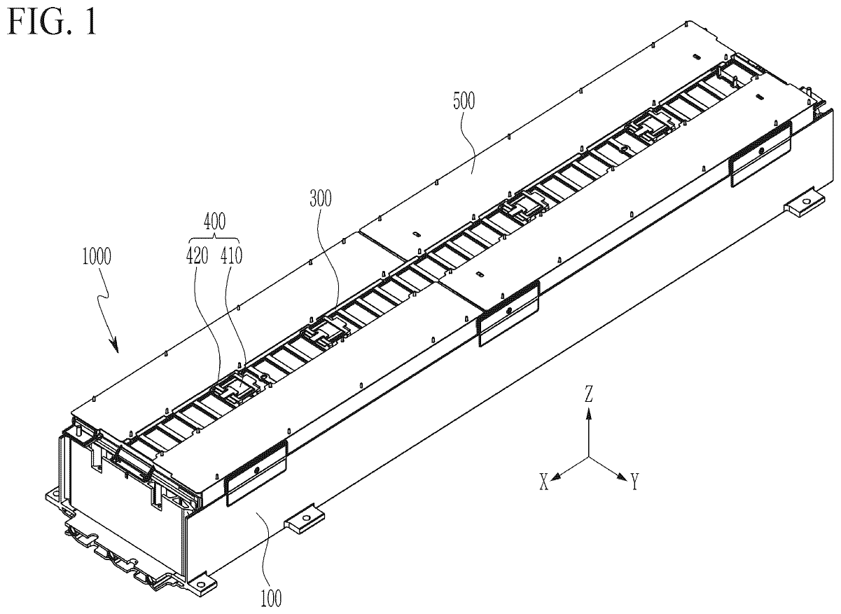

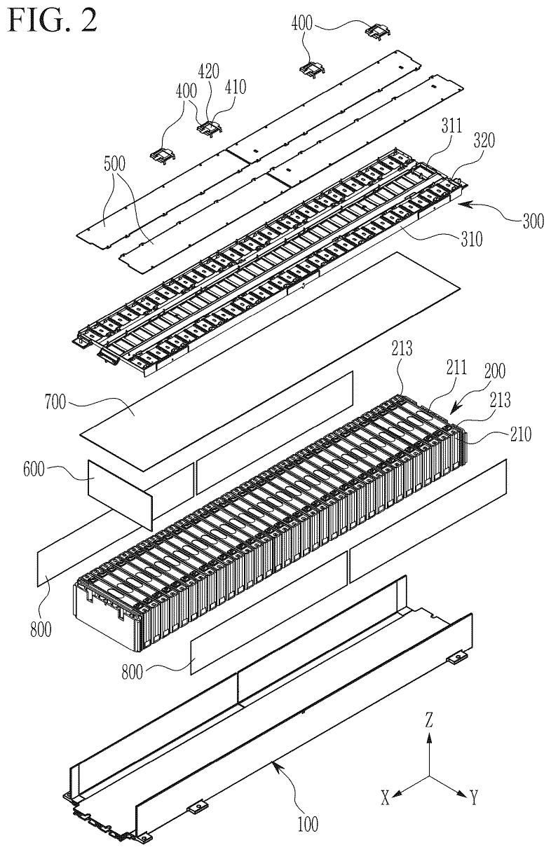

FIG. 1 is a perspective view of a battery pack 1000 according to one or more embodiments of the present disclosure. FIG. 2 is an exploded perspective view illustrating the battery pack 1000 as illustrated in FIG. 1. Referring to FIGS. 1 and 2, the battery pack 1000 may include a module case 100 and a battery module 200 accommodated inside the module case 100 and including a plurality of battery cells 210 (for convenience, only one battery cell is indicated by a symbol).

In an XYZ coordinate system setup of FIGS. 1 and 2, an X-axis direction may indicate a longitudinal direction of the battery pack 1000 or a stacking direction of the battery cells 210. A Y-axis direction may indicate a width direction of the battery pack 1000 or a longitudinal direction of the battery cells 210, and a Z-axis direction may indicate a height direction of the battery pack 1000 or the battery cells 210. The X-axis, Y-axis, and Z-axis are each orthogonal to each other.

The battery pack 1000 may further include a busbar assembly 300 on the battery module 200. An extinguishing sheet assembly 400 may be on the busbar assembly 300.

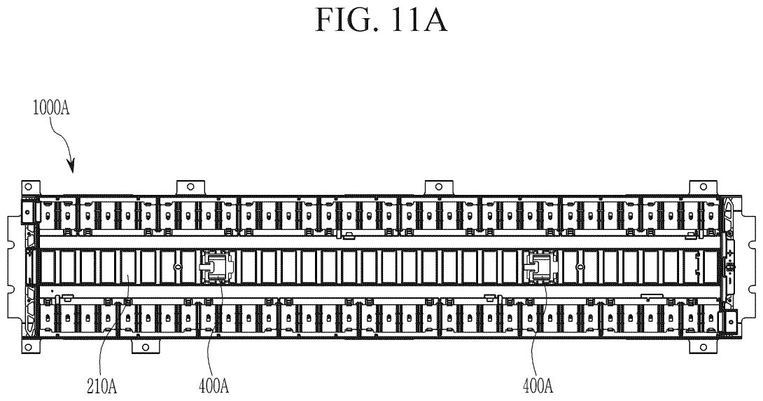

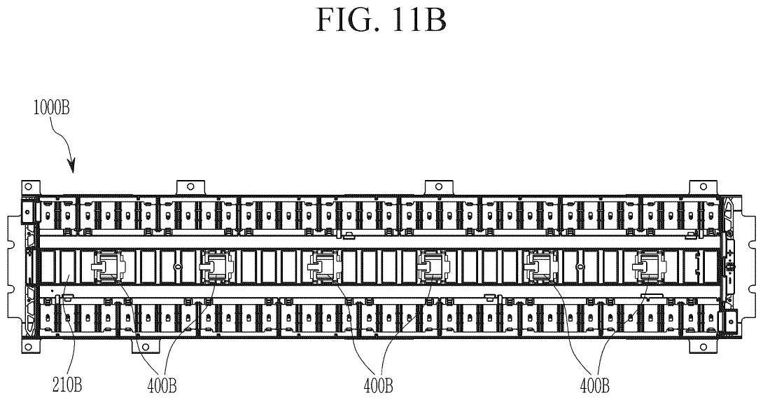

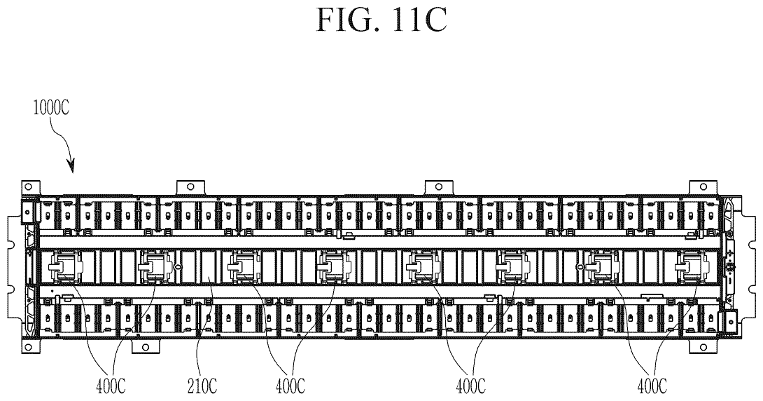

In FIGS. 1 and 2, four extinguishing sheet assemblies 400 are illustrated, but this is merely an example, and quantity and arrangement may be varied depending on a desired or required heat propagation suppression (or reduction) effect. A more detailed description of a battery pack including extinguishing sheet assemblies will be provided herein with reference to FIG. 11A to 11C.

The busbar assembly 300 may include a busbar holder 310 and a busbar 320. The busbar holder 310 may be positioned or arranged on the battery module 200 to guide the busbar 320 to be positioned or arranged at a preset position and may fix the busbar 320 such that it is maintained at the position. Furthermore, the busbar holder 310 may be to block electrical interference (or reduce a degree or occurrence of electrical interference) between the battery cells 210 and the busbar 320.

The busbar holder 310 may have a plurality of terminal holes to expose an electrode terminal 213 of each of the battery cells 210. The electrode terminal 213 of each battery cell 210 may be connected to the bus bar 320 through the terminal holes. For example, different battery cells 210 may be electrically connected to each other through connection of the electrode terminal 213 and the busbar 320. The electrode terminal 213 and the busbar 320 may be connected by welding, but embodiments of the present disclosure are not limited thereto.

The busbar assembly 300 may further include a circuit board. The circuit board may be positioned or arranged on the busbar holder 310. The circuit board may include a flexible printed circuit board (FPCB). The circuit board may be electrically connected to the busbar 320 to obtain information (e.g., temperature, voltage, and/or the like) from the battery cells 210.

The busbar holder 310 may have a plurality of exhaust ports 311 to expose vent holes 211 of the respective battery cells 210. The exhaust ports 311 may be positioned or arranged at positions that correspond to positions of the vent holes 211 of the respective battery cell 210 so that exhaust gas discharged through the vent holes 211 may be smoothly discharged to the outside of the battery pack 1000. The extinguishing sheet assembly 400 may be detachably attached to the busbar holder 310 on the exhaust ports 311.

Attachment of the extinguishing sheet assembly 400 may indicate that a portion of any suitable component of the extinguishing sheet assembly 400 is physically connected by engaging with a portion of any suitable component of the busbar holder 310 and does not indicate that it is bonded by a chemical substance (e.g., adhesive) and/or the like.

The extinguishing sheet assembly 400 may be moved from a first side of the busbar assembly 300 toward the busbar assembly 300, e.g., in the −Z-axis direction (downward direction with respect to FIG. 2) and attached to the busbar assembly 300. For example, the extinguishing sheet assembly 400 may be detachably attached to the busbar holder 310 of the busbar assembly 300, and the attachment position may be such that it covers at least one selected from among the exhaust ports 311 of the busbar holder 310.

The extinguishing sheet assembly 400 may include an extinguishing sheet 410 that contains an extinguishing agent and a case 420 in which the extinguishing sheet 410 is detachably received, with an exposed region.

The extinguishing agent included in the extinguishing sheet 410 may be a solid aerosol. The solid aerosol may contain either potassium carbonate (K₂CO₃) or potassium nitrate (KNO₃) as a main or predominant component thereof, and if (e.g., when) heated above a certain (e.g., set or predetermined) temperature (e.g., about 250° C.), it may combust to produce an aerosol extinguishing gas.

Potassium carbonate or potassium nitrate, which is the main or predominant component of the aerosol extinguishing gas, may perform an extinguishing function by chemically reacting with hydrogen fluoride (HF) generated during combustion of the battery cells 210, removing hydrogen fluoride and generating carbon dioxide, an extinguishing component. Accordingly, even if (e.g., when) ignition occurs due to thermal runaway in the battery cells 210, the ignition may be extinguished through the solid aerosol, and heat propagation to cells that are around (or surrounding cells) may be suppressed or reduced.

The battery pack 1000 may further include at least one selected from among a first insulating sheet 500, a second insulating sheet 600, a third insulating sheet 700, and a fourth insulating sheet 800.

The first insulating sheet 500 may be positioned or arranged on the busbar assembly 300 to suppress heat propagation (or to reduce a degree or occurrence of heat propagation) in a +Z-axis direction (upward direction of the battery module 200 based on FIG. 2). The second insulating sheet 600 may be provided between adjacent battery cells 210 among the battery cells 210 to suppress heat propagation (or to reduce a degree or occurrence of heat propagation) between the battery cells 210.

The third insulation sheet 700 may be positioned or arranged between the busbar assembly 300 and the battery module 200 to suppress heat propagation (or to reduce a degree or occurrence of heat propagation) in the +Z-axis direction (upward direction of the battery module 200 based on FIG. 2). The fourth insulating sheet 800 may be positioned or arranged between the battery module 200 and the module case 100 to suppress heat propagation (or to reduce a degree or occurrence of heat propagation) in a Y-axis direction (longitudinal direction of the battery cell 210 based on FIG. 2).

For example, even before thermal runaway occurs in any one battery cell 210, the battery pack 1000 may suppress heat (or reduce a degree or occurrence of heat) generated in the battery cell 210 from being transferred to the battery cells 210 that are around (or surrounding battery cells 210) or other components of the battery pack 1000 (e.g., the busbar assembly 300 or the module case 100) by including at least one selected from among the first insulating sheet 500, the second insulating sheet 600, the third insulating sheet 700, and the fourth insulation sheet 800.

Furthermore, even after thermal runaway occurs in one battery cell 210, the battery pack 1000 may be to suppress heat propagation (or reduce a degree or occurrence of heat propagation) to battery cells 210 that are around (or surrounding battery cells 210) or other components of the battery pack 1000 through at least one selected from among the first insulating sheet 500, the second insulating sheet 600, the third insulating sheet 700, and the fourth insulation sheet 800 and may be to absorb physical shock, thereby preventing damage (or reducing a degree or occurrence of damage) due to external shock.

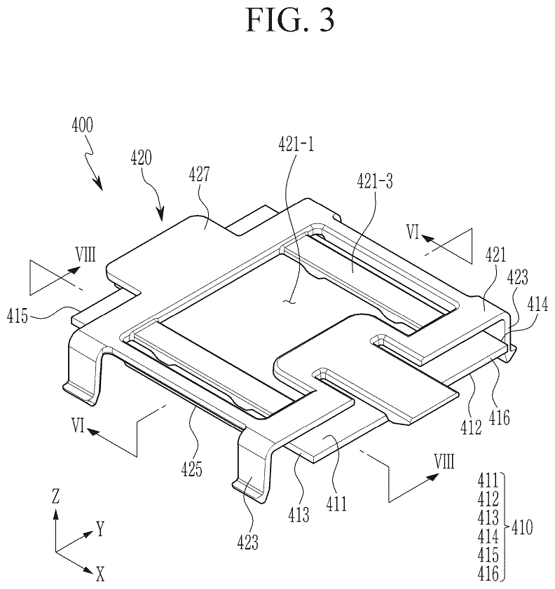

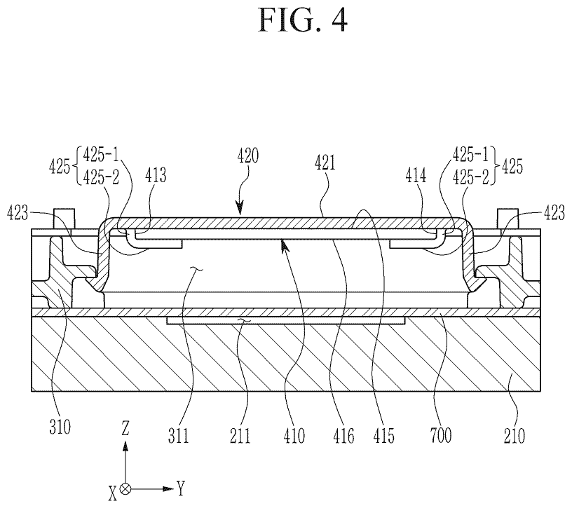

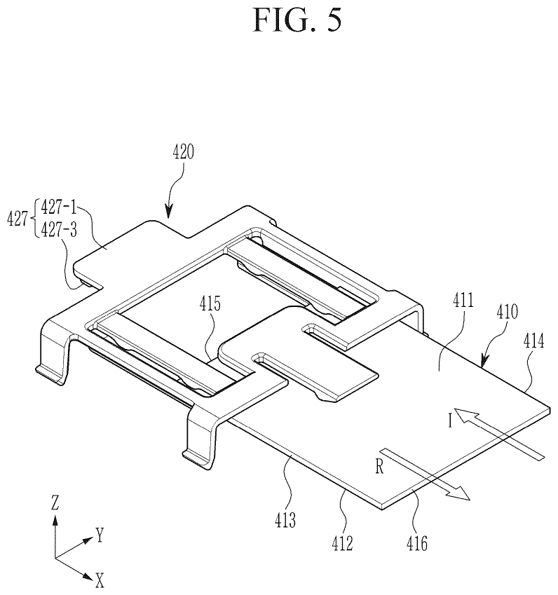

FIG. 3 is a perspective view of an extinguishing sheet assembly 400 according to one or more embodiments of the present disclosure. FIG. 4 is a partial cross-sectional view illustrating the extinguishing sheet 400 assembly coupled to a battery pack 1000. FIG. 5 illustrates a process of inserting or removing an extinguishing sheet 410 into or from a case 420.

The XYZ coordinate system settings of FIGS. 3 to 5 may each independently be substantially the same as the XYZ coordinate system settings of FIGS. 1 and 2, but in each drawing, the X-axis direction may indicate a longitudinal direction of the extinguishing sheet 410, the Y-axis direction may indicate a width direction of the extinguishing sheet 410, and the Z-axis direction may indicate a thickness direction of the extinguishing sheet 410.

Referring to FIGS. 3 to 5, the extinguishing sheet 410 may have one or more surfaces. The extinguishing sheet 410 is described in more detail herein as an example having a rectangular parallelepiped shape (e.g., a substantially rectangular parallelepiped shape) with a total of six surfaces. However, embodiments of the present disclosure are not limited thereto, and the extinguishing sheet 410 may have one or more suitable shapes. For example, the extinguishing sheet 410 may have a circular cross-section shape (e.g., a substantially circular cross-section shape) and a shape of a circular patch (e.g., a shape of a substantially circular patch) with three surfaces.

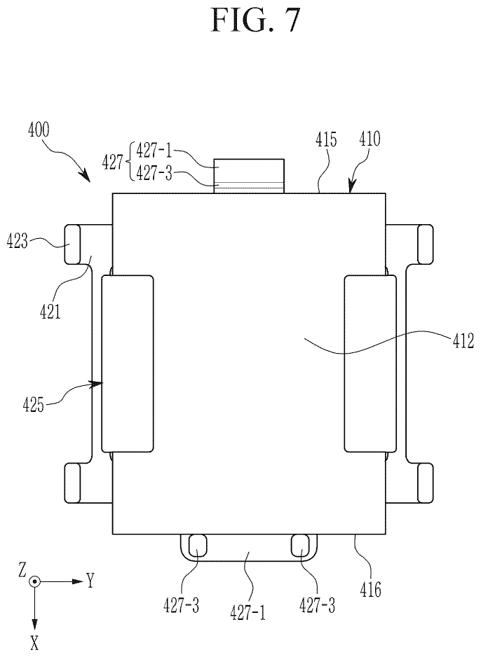

In one or more embodiments, the extinguishing sheet 410 may have a first surface 411 that corresponds to an upper surface with reference to FIG. 3, a second surface 412 (see also FIG. 7) that corresponds to a lower surface, a third surface 413 that corresponds to a left surface, a fourth surface 414 that corresponds to a right surface, a fifth surface 415 that corresponds to a front surface, and a sixth surface 416 that corresponds to a rear surface.

The case 420 may include a body 421, a plurality of legs 423 that extends from the body 421, and a receiving portion 425 that receives the extinguishing sheet 410 that extends from the body 421 and inserted into the case 420.

The legs 423 may be configured or arranged to allow the extinguishing sheet assembly 400 to be removably attached to the battery module 200. Each of the legs 423 may have, e.g., a snap-fit structure.

Accordingly, the extinguishing sheet assembly 400 may be detachably attached to the busbar holder 310 while covering the exhaust ports 311 of the busbar holder 310 over the busbar assembly 300 through the legs 423. Herein, a position at which the extinguishing sheet assembly 400 is attached may correspond to a position of the vent hole 211 of the battery cell 210. Each of the legs 423 may have a snap-fit structure, so the extinguishing sheet assembly 400 may be easily attached to the busbar holder 310 manufactured to a set standard without additional design or manufacturing.

The receiving portion 425 may prevent the extinguishing sheet 410 received inside the case 420 from being detached (or reduce a degree to or occurrence of which the extinguishing sheet 410 received inside the case 420 is detached). For example, the extinguishing sheet 410 may be prevented from falling in the −Z-axis direction (downward direction based on FIG. 4) (or a degree to or occurrence of which the extinguishing sheet 410 falls in the −Z-axis direction (downward direction based on FIG. 4) may be reduced).

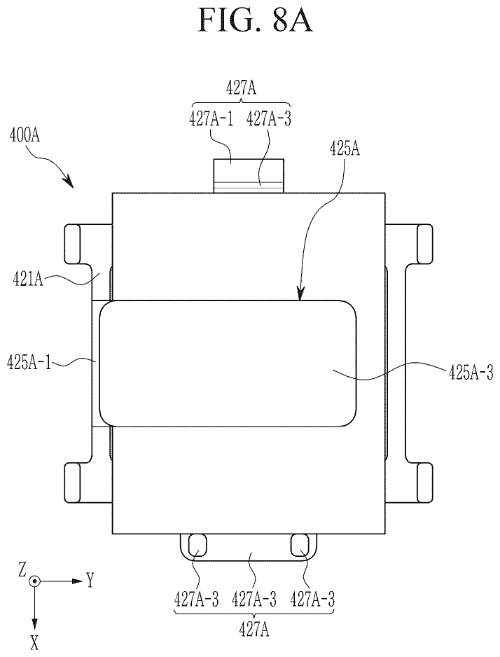

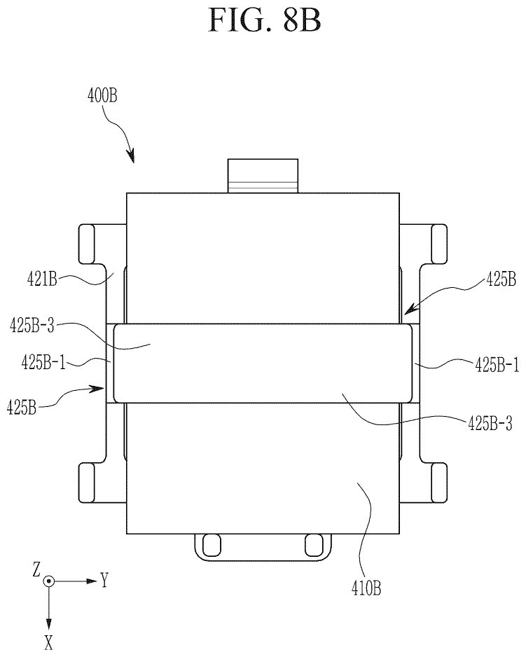

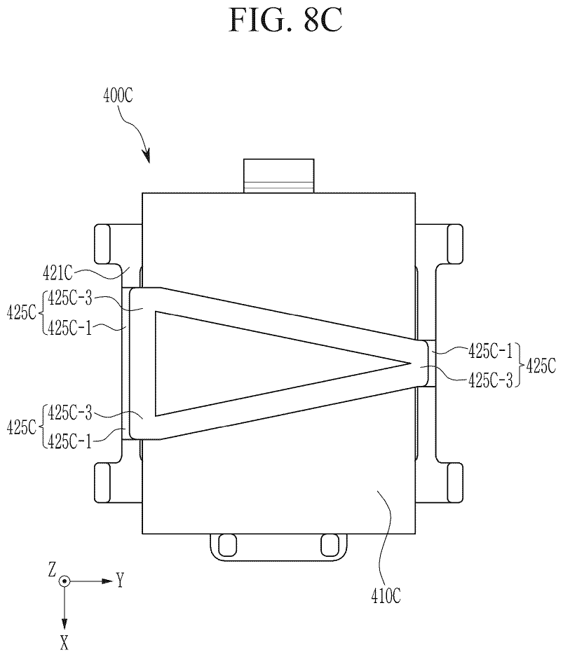

In one or more embodiments, a number of receiving portions 425 may be, for example, two, but embodiments of the present disclosure are not limited to the number and arrangement thereof. One or more suitable variations of the number and arrangement of the receiving portions 425 will be described in more detail herein with reference to FIGS. 8A to 8C.

In the case where there are two receiving portions 425, they may be formed or arranged to extend from the body 421 at an equal (e.g., substantially equal) distance in opposite directions along the X-axis. For example, two receiving portions 425 may each extend from a surface at one side of opposite end portions of the body 421.

The case 420 may further include a movement restriction portion 427 to restrict a movement of the extinguishing sheet 410. The movement restriction portion 427 may extend from the body 421. For example, the movement restriction portion 427 may be to restrict the movement of the extinguishing sheet 410 in the X-axis direction.

In one or more embodiments, the movement restriction portion 427 may include a second connection portion 427-1 connected to/with the body 421 and a protrusion 427-3 to restrict the movement of the extinguishing sheet 410 in the X-axis direction. The second connecting portion 427-1 may extend in the X-axis direction from the body 421 and may come into contact with the first surface 411 of the extinguishing sheet 410.

The protrusion 427-3 may be formed or arranged by protruding a portion of the second connecting portion 427-1 in the −Z-axis direction. For example, the protrusion 427-3 may extend from the second connecting portion 427-1 in a thickness direction of the extinguishing sheet 410. The protrusion 427-3 may be formed or arranged to contact the fifth surface 415 or the sixth surface 416 of the extinguishing sheet 410.

There may be one or more movement restriction portions 427. If (e.g., when) there are two movement restriction portions 427, the movement restriction portions 427 may be formed or arranged in the +X-axis direction and the −X-axis direction, respectively. The second connecting portion 427-1 of each movement restriction portion 427 may extend from the body 421 in the +X-axis direction and the −X-axis direction, and the protrusion 427-3 of each movement restriction portion 427 may all protrude in the −Z-axis direction. The protrusion 427-3 of each movement restriction member 427 may be in contact with the fifth surface 415 or the sixth surface 416 of the extinguishing sheet 410 and may be to restrict the movement of the extinguishing sheet 410 in the +X-axis and −X-direction.

The body 421 may have an opening 421-1 formed or arranged through the Z-axis direction. A portion of the first surface 411 of the extinguishing sheet 410 may be exposed through the opening 421-1. An area of the extinguishing sheet 410 exposed by the opening 421-1 may be about 70% or more of a total area of the extinguishing sheet 410. The body 421 may have an opening 421-1, so an entire (e.g., substantially entire) exposed area of the extinguishing sheet 410 may be increased.

The extinguishing sheet 410 may be more sensitive to ambient temperature (e.g., ambient temperature of the battery cells) due to the increased exposed area, and the aerosol extinguishing gas generated by action of the extinguishing sheet 410 may also be discharged more from the case 420, thereby increasing or enhancing extinguishing and heat propagation suppression (or reduction) effects of the extinguishing sheet 410.

The body 421 may further include a support member 421-3 positioned or arranged inside the opening 421-1. The support member 421-3 may increase or enhance mechanical stability of the case 420. In one or more embodiments, the support member 421-3 may be positioned or arranged adjacent to each receiving portion 425.

The extinguishing sheet 410 may be inserted into the case 420 in a direction I (−X-axis direction based on FIG. 5) and may be removed from the case 420 in a direction R (+X-axis direction based on FIG. 5).

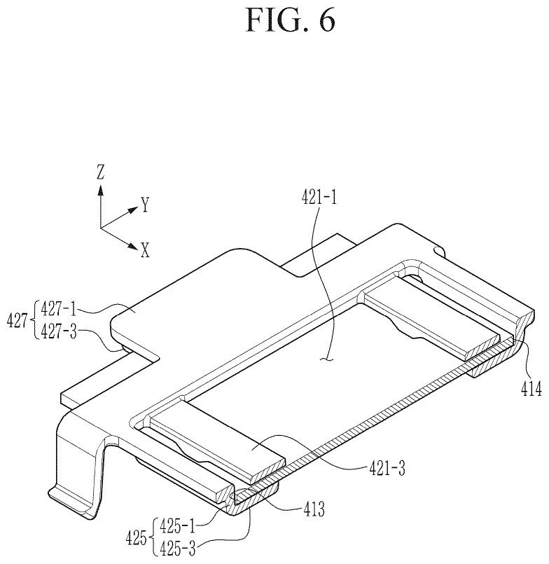

FIG. 6 is a cross-sectional view taken along the line VI-VI as shown in FIG. 3. FIG. 7 is a bottom view of the extinguishing sheet assembly 400 as illustrated in FIG. 3.

Referring to FIGS. 6 and 7, the receiving portion 425 may include a first connecting portion 425-1 that extends from the body 421 and a guide portion 425-3 connected to the body 421 through the first connecting portion 425-1 and that supports the extinguishing sheet 410. The first connecting portion 425-1 may be in contact with the third surface 413 or the fourth surface 414 of the extinguishing sheet 410, and the guide portion 425-3 may be in contact with the second surface 412 of the extinguishing sheet 410. Accordingly, the extinguishing sheet 410 may be supported not only by the guide portion 425-3 but also by the first connecting portion 425-1.

A height of the first connecting portion 425-1 may be equal to or greater than a thickness of the extinguishing sheet 410. For example, the extinguishing sheet 410 may be accommodated in the receiving portion 425 such that the first surface 411 is in contact with the body 421 or may be accommodated in the receiving portion 425 such that the first surface 411 is spaced from the body 421.

If (e.g., when) the extinguishing sheet 410 is spaced and/or apart (e.g., spaced apart or separated) from the body 421 so that a space is formed or arranged between the extinguishing sheet 410 and the body 421, the extinguishing sheet 410 may be moved more easily in the X-axis direction. Accordingly, insertion of the extinguishing sheet 410 into the case 420 or removal from the case 420 may be made relatively easier.

The guide portion 425-3 of each receiving portion 425 may not be connected to each other. In one or mor embodiments, the exposed area of the extinguishing sheet 410 accommodated inside case 420 may increase. For example, the exposure area of the second surface 412 of the extinguishing sheet 410 may be increased. If (e.g., when) the exposure area of the extinguishing sheet 410 is increased, the extinguishing sheet 410 may react more sensitively to the temperature around (or the surrounding temperature) and gasify more quickly, and more aerosol extinguishing gas may be discharged toward the battery cells 210, thereby effectively or suitably extinguishing ignition caused by the thermal runaway event.

Furthermore, a contact area of a surface of the guide portion 425-3 that comes into contact with the second surface 412 of the extinguishing sheet 410 may be greater than the thickness of the extinguishing sheet 410. By the action of this structure, the extinguishing sheet 410 may be moved easily and stably in the X-axis direction within the body 421. This makes it easy or feasible to replace the extinguishing sheet 410.

FIG. 8A to FIG. 8C illustrate one or more examples in which the number and arrangement of receiving portions 425 are modified. FIG. 8A is a bottom view of an extinguishing sheet assembly 400A including one receiving portion 425A. FIG. 8B is a bottom view of an extinguishing sheet assembly 420B including two receiving portions 425B but with each guide portion 425B-3 connected thereto. FIG. 8C is a bottom view of an extinguishing sheet assembly 420C including three receiving portions 425C.

As illustrated in FIG. 8A, if (e.g., when) there is one receiving portion 425A, the receiving portion 425A may be configured or arranged by extending a first connecting portion 425A-1 from a first side (left side based on FIG. 8A) of a body 421A to have a set or predetermined length and height and extending a guide portion 425A-3 from a first end of the first connecting portion 425A-1 in a direction toward the Y-axis. Herein, the guide portion 425A-3 may be extended to a periphery of a second side (right side based on FIG. 8A) of the body 421A.

In one or more embodiments, the receiving portion 425A may be positioned or arranged at a position of the movement restriction portion 427A, in which case it may also perform a function of the movement restriction portion 427A.

As illustrated in FIG. 8B, if (e.g., when) there are two receiving portions 425B, the guide portion 425B-3 of the respective receiving portions 425B may be connected to each other. In one or mor embodiments, the movement of the extinguishing sheet 410B in the Z-axis direction may be further restricted, and mechanical stability may be further provided to the extinguishing sheet assembly 400B.

As illustrated in FIG. 8C, if (e.g., when) there are three receiving portions 425C, one receiving portion 425C may be positioned or arranged substantially parallel to the X-axis direction on a first side of a body 421C (the left side based on FIG. 8C), and two other receiving portions 425C may be connected at an angle to opposite ends of the one receiving portion 425C and fixed to a second side of the body 421C (the right side based on FIG. 8C), so it may be configured or arranged in a so-called triangular arrangement. For example, at least one or more selected from among the guide portions 425C-3 of the respective receiving portions 425C may be connected to each other.

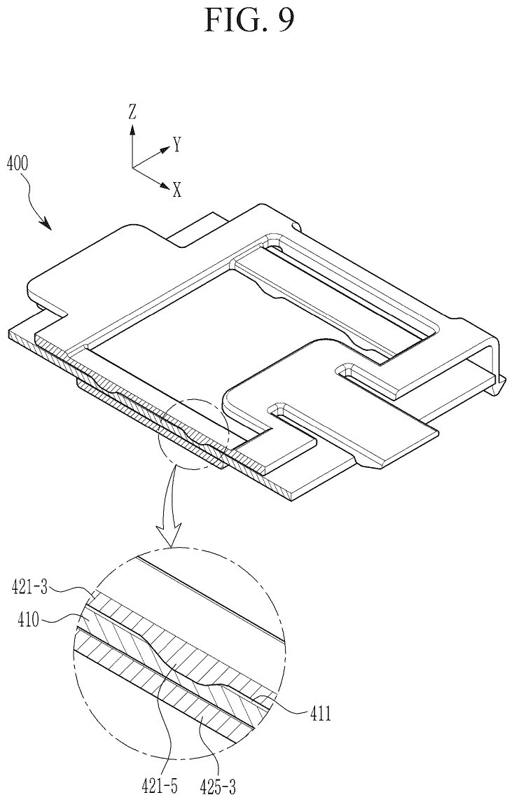

FIG. 9 is a cross-sectional view taken along the line VIII-VIII as shown in FIG. 3. Referring to FIG. 9, the extinguishing sheet assembly 400 may further include a projection 421-5 that protrudes in the −Z direction from a surface of the supporting member 421-3. The projection 421-5 may pressurize the first surface 411 of the extinguishing sheet 410 to restrict the movement of the extinguishing sheet 410.

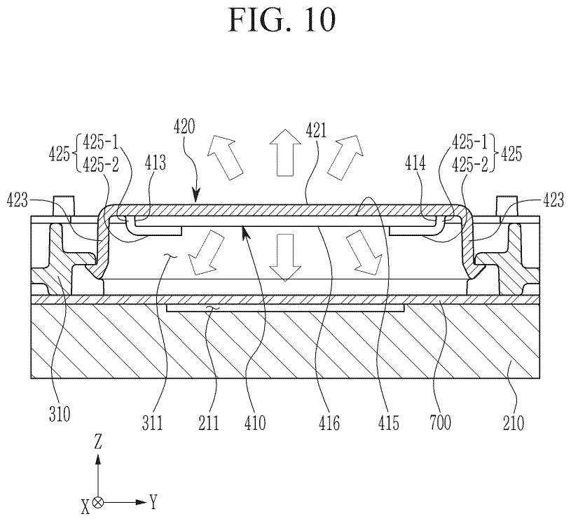

FIG. 10 illustrates how the extinguishing sheet assembly 400 works or functions. Referring to FIG. 10, if (e.g., when) a thermal runaway event occurs in one battery cell 210 included in the battery module 200, a temperature may rise around the battery cell 210 where the thermal runaway occurred. As the temperature around (or the surrounding temperature) rises, an extinguishing agent may be gasified and discharged from the extinguishing sheet 410 (see arrow direction as shown in FIG. 10).

According to one or more embodiments of the present disclosure, the extinguishing sheet assembly 400 may have a large exposed area to react immediately to the temperature around (or the surrounding temperature), and the aerosol extinguishing gas by vaporization of the extinguishing sheet 410 may be discharged from the case 420 at a wider range and at a wider angle. This may allow for effective or suitable fire extinguishment and heat propagation suppression or reduction.

FIG. 11A to 11C illustrate examples in which the number and arrangement of the extinguishing sheet assemblies 400 are varied according to one or more embodiments of the present disclosure. FIG. 11A is a top plan view of a battery pack 1000A including two extinguishing sheet assemblies 400. FIG. 11B is a top plan view of a battery pack 1000B including six extinguishing sheet assemblies 400. FIG. 11C is a top plan view of a battery pack 1000C including eighth extinguishing sheet assemblies 400.

Referring to FIG. 11A to FIG. 11C, the battery pack 1000 may be arranged with one or more suitable variations in a number of extinguishing sheet assemblies 400. For example, the number and arrangement of the extinguishing sheet assemblies 400 may be adjusted in one or more suitable ways depending on the desired or required heat propagation suppression (or reduction) effect.

For example, a battery pack 1000A may include two extinguishing sheet assemblies 400A, in which case it may take several minutes (e.g., about 5 minutes) for heat to propagate across all battery cells 210A. In one or mor embodiments, each extinguishing sheet assembly 400A may be positioned or arranged at a position that divides an entire length of the stacked battery cells 210A into three equal parts.

For example, a battery pack 1000 may include six extinguishing sheet assemblies 400, in which case it may take tens of minutes (e.g., about 15 minutes) for heat to propagate across all battery cells 210. In one or mor embodiments, each extinguishing sheet assembly 400B may be positioned or arranged at a position that divides an entire length of the stacked battery cells 210B into seven equal parts.

For example, a battery pack 1000 may include eight extinguishing sheet assemblies 400, in which case it may take tens of minutes (e.g., about 20 minutes) for heat to propagate across all battery cells 210. In one or mor embodiments, each extinguishing sheet assembly 400C may be positioned or arranged at a position that divides an entire length of the stacked battery cells 210C into nine equal parts.

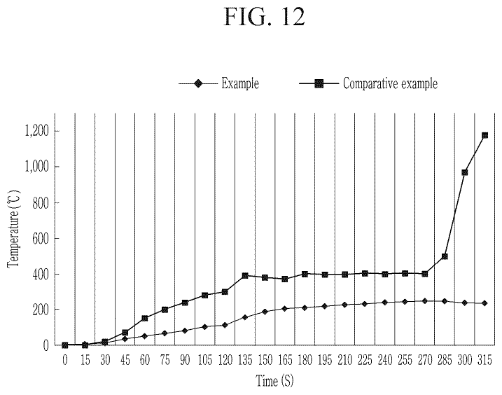

FIG. 12 is a graph illustrating a heat propagation suppression (or reduction) effect of a battery pack 1000 according to an example of the present disclosure and a battery pack 1000′ according to a comparative example. The battery pack 1000′ according to the comparative example includes substantially the same configuration or arrangement as that of the battery pack 1000 according to the example of the present disclosure, but does not include the extinguishing sheet assembly 400.

FIG. 12 is a graph of a temperature at a point between a battery cell where thermal runaway has occurred and its neighboring battery cell over time. If (e.g., when) thermal runaway occurs in a single battery cell, a temperature around (e.g., surrounding) the battery cell where thermal runaway occurs may rise to over 250° C.

Referring to FIG. 12, it may be confirmed that in a battery pack 1000 according to the example of the present disclosure, a temperature at a point between a battery cell where thermal runaway has occurred and an adjacent battery cell reaches 200° C. only after 150 seconds, and the temperature does not rise above about 250° C. For example, it may be confirmed that heat propagation between battery cells is suppressed or reduced.

For example, if (e.g., when) the ambient temperature rises above 250° C., the extinguishing sheet 410 may operate to discharge an aerosol extinguishing gas, thereby quickly extinguishing a fire that occurs in a battery cell where thermal runaway has occurred.

In contrast, in the case of the battery pack 1000′ according to the comparative example, it may be confirmed that the temperature between one battery cell where the thermal runaway event occurred and the adjacent battery cell reaches 200° C. in less than 90 seconds, and the temperature does not decrease thereafter but continues to increase. For example, it may be confirmed that heat propagation between battery cells is not suppressed or reduced because there is no means to quickly extinguish the resulting ignition even if (e.g., when) thermal runaway occurs in one battery cell.

Referring to FIG. 12, if (e.g., when) the battery pack 1000 includes the extinguishing sheet assembly 400, the extinguishing sheet 410 may react immediately to the temperature around (or the surrounding temperature) and effectively or suitably suppresses or reduces ignition and suppresses or reduces heat propagation to cells around (or surrounding cells) by discharging a large amount of aerosol gas in one or more suitable directions to the surroundings.

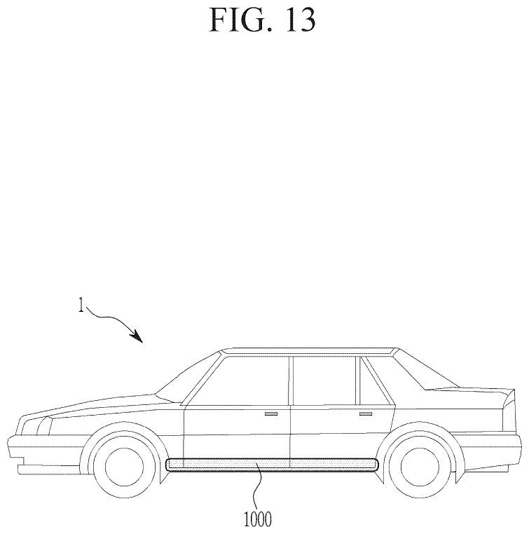

FIG. 13 is a side view of an electric vehicle 1 including the battery pack 1000 according to one or more embodiments of the present disclosure. The electric vehicle 1 may include the battery pack 1000.

A battery manufacturing device, a battery management system (BMS) device, and/or any other relevant devices or components according to one or more embodiments of the present disclosure may be implemented utilizing any suitable hardware, firmware (e.g., an application-specific integrated circuit), software, and/or a (e.g., any suitable) combination of software, firmware, and hardware. For example, one or more suitable components of the device may be provided on one integrated circuit (IC) chip or on separate IC chips. Further, one or more suitable components of the device may be implemented on a flexible printed circuit film, a tape carrier package (TCP), a printed circuit board (PCB), and/or provided on one substrate. Further, the one or more suitable components of the device may be a process or thread, running on one or more processors, in one or more computing devices, executing computer program instructions and interacting with other system components to perform the one or more suitable functionalities described herein. The computer program instructions may be stored in a memory which may be implemented in a computing device utilizing a standard memory device, such as, for example, a random access memory (RAM). The computer program instructions may also be stored in other non-transitory computer readable media, such as, for example, a CD-ROM, a flash drive, and/or the like. Also, a person of skill in the art should recognize that the functionality of one or more suitable computing devices may be combined or integrated into a single computing device, or the functionality of a particular computing device may be distributed across one or more other computing devices without departing from the scope of the present disclosure.

While the subject matter of the present disclosure has been described in connection with what is presently considered to be practical example embodiments, it is to be understood that the present disclosure is not limited to the disclosed embodiments, but, in one or more embodiments, is intended to cover one or more suitable modifications and equivalent arrangements included within the spirit and scope of the appended claims and equivalents thereof. It therefore will be understood that one or more embodiments described herein are just illustrative but not limitative in all aspects.

Reference Numerals

| | |
|---|---|
| 1: electric vehicle | 100: module case |
| 200: battery module | 210: battery cell |
| 211: vent hole | 300: busbar assembly |
| 310: busbar holder | 311: exhaust port |
| 320: busbar | 330: circuit board |
| 400: extinguishing sheet assembly | 410: extinguishing sheet |
| 411: first surface | 412: second surface |
| 413: third surface | 414: fourth surface |
| 415: fifth surface | 416: sixth surface |
| 420: case | 421: body |
| 421-1: opening | 421-3: support member |
| 421-5: projection | 423: leg |
| 425: receiving portion | 425-1: first connecting portion |
| 425-3: guide portion | 427: movement restriction portion |
| 427-1: second connecting portion | 427-3: protrusion |
| 500: first insulating sheet | 600: second insulating sheet |
| 700: third insulating sheet | 800: fourth insulating sheet |
| 1000: battery pack | |

What is claimed is:

1. An extinguishing sheet assembly comprising:
an extinguishing sheet comprising an extinguishing agent; and
a case in which the extinguishing sheet is detachably received and comprises an exposed area,
wherein the case comprises:
a body;
a plurality of legs extended from the body to support the body; and
a receiving portion extended from the body and into which the extinguishing sheet is inserted.

2. The extinguishing sheet assembly as claimed in claim 1, wherein the receiving portion comprises:
a guide portion to support the extinguishing sheet while contacting a second surface of the extinguishing sheet; and
a first connecting portion connected to the guide portion and the body, and
wherein an area in contact between the guide portion and the second surface is equal to or greater than a thickness of the extinguishing sheet.

3. The extinguishing sheet assembly as claimed in claim 1, further comprising a plurality of receiving portions comprising the receiving portion,
wherein each of the plurality of receiving portions comprises:
a guide portion to support the extinguishing sheet while contacting a second surface of the extinguishing sheet; and
a first connecting portion connected to the guide portion and the body, and
wherein an area in contact between the guide portion and the second surface is equal to or greater than a thickness of the extinguishing sheet.

4. The extinguishing sheet assembly as claimed in claim 3, wherein at least one or more selected from among the guide portions of the respective receiving portions are connected to each other.

5. The extinguishing sheet assembly as claimed in claim 1, wherein the case further comprises a movement restriction portion extended from the body to restrict a movement of the extinguishing sheet in a longitudinal direction.

6. The extinguishing sheet assembly as claimed in claim 5, wherein the movement restriction portion comprises:
a second connecting portion extended from the body; and
a protrusion extended from the second connecting portion in a thickness direction of the extinguishing sheet.

7. The extinguishing sheet assembly as claimed in claim 1, wherein the body has an opening.

8. The extinguishing sheet assembly as claimed in claim 7, wherein the body further comprises a support member in the opening.

9. The extinguishing sheet assembly as claimed in claim 8, wherein the support member comprises a projection protruded in a thickness direction of the extinguishing sheet.

10. The extinguishing sheet assembly as claimed in claim 1, wherein the plurality of legs has a snap-fit structure.

11. The extinguishing sheet assembly as claimed in claim 1, wherein the case is arranged to expose about 70% or more of a total area of the extinguishing sheet.

12. The extinguishing sheet assembly as claimed in claim 1, wherein the extinguishing agent is a solid aerosol.

13. A battery pack comprising:
a battery module comprising a plurality of battery cells;
a module case to accommodate the battery module;
a busbar assembly on the battery module for electrical connection of the plurality of battery cells; and
the extinguishing sheet assembly as claimed in claim 1 that is removably attached to the busbar assembly.

14. The battery pack as claimed in claim 13, further comprising:
at least one selected from among a first insulating sheet on the busbar assembly to suppress heat propagation, a second insulating sheet between adjacent battery cells among the plurality of battery cells to suppress heat propagation, a third insulating sheet between the busbar assembly and the battery module to suppress heat propagation, and a fourth insulating sheet between the battery module and the module case.

15. An electric vehicle comprising the battery pack as claimed in claim 13.
